(19) United States
(12) Patent Application Publication
(10) Pub. No.: US 2017/0274648 A1
(43) Pub. Date: Sep. 28, 2017

(54) METHOD FOR OPERATING AN INKJET PRINT HEAD AND AN INKJET PRINT HEAD ASSEMBLY

(71) Applicant: Océ Holding B.V., Venlo (NL)

(72) Inventors: Roel M.P. HEIJNEN, Venlo (NL); Johannes A.T. GOLLATZ, Venlo (NL)

(73) Assignee: Océ Holding B.V., Venlo (NL)

(21) Appl. No.: 15/455,889

(22) Filed: Mar. 10, 2017

(30) Foreign Application Priority Data
Mar. 24, 2016 (EP) 16162422.6

(51) Int. Cl. B41J 2/045

(52) U.S. Cl. CPC B41J 2/04588; B41J 2/04581

(57) ABSTRACT

In a method for operating an inkjet print head for generating a droplet of a liquid, the inkjet print head comprises a number of ejection units, each ejection unit comprising a piezo-electric actuator having a signal electrode, a common electrode and a piezo-electric layer interposed between the signal electrode and the common electrode. The method comprises providing a non-jetting pulse signal on a common electrode, wherein the non-jetting pulse signal is adapted to generate a pressure wave in the liquid in the corresponding ejection unit without expelling a droplet of the liquid. The method further comprises providing a jetting pulse signal on a signal electrode, wherein the jetting pulse signal is adapted to generate a pressure wave in the liquid in the corresponding ejection unit such that a droplet of the liquid is expelled.

Further, an inkjet print head assembly comprising an inkjet print head and a control circuitry is provided. The inkjet print head assembly is configured for performing the above method.

### FIELD OF THE INVENTION

The present invention generally pertains to a method for operating an inkjet print head and a corresponding inkjet print head assembly configured to perform the method.

### BACKGROUND ART

Inkjet print heads are commonly known. Some types of inkjet print heads employ an piezo-electric actuator for generating a pressure wave in a liquid that is arranged in a pressure chamber of an ejection unit. Such ejection unit further comprises a nozzle orifice in fluid communication with the pressure chamber. If the pressure wave has suitable properties, the generated pressure wave may result in a droplet of the liquid being expelled through the corresponding nozzle orifice.

It is known to apply a pressure wave that results in a meniscus of the liquid in or near the nozzle orifice being vibrated. Such vibration of the meniscus enables to prevent drying of the ink, for example. The vibration may also be used as a pre-fire vibration, for example for generating more uniform droplets. Another known application of a non-jetting drive pulse is for probing the ejection unit for disturbances, wherein a residual pressure wave is detected after application of the drive pulse. The residual pressure wave is then analyzed with respect to the acoustics in the ejection unit.

Commonly, the piezo-actuator is driven by application of a drive pulse generated by suitable driver circuitry. Application of a jetting pulse signal, i.e. a drive signal resulting in a droplet of liquid being expelled, or a non-jetting pulse signal, i.e. a drive signal not resulting in a droplet being expelled, is performed by applying the drive pulse to a signal electrode of the piezo-actuator.

A disadvantage of this known method of applying different drive pulses to a single signal electrode is the complexity of the driver circuitry.

In U.S. Pat. No. 8,038,265 it is suggested to provide a piezo-actuator with two signal electrodes and a common ground electrode. Depending on whether one or both signal electrodes receive a drive pulse, the meniscus is vibrated or a droplet is expelled. In this arrangement, the number of lead electrodes to the different signal electrodes is significantly increased, while in the present inkjet print heads there is relatively little space due to the desire of increased density of ejection units in view of a desired high print resolution.

It is an object of the present invention to provide for a method and assembly requiring a simplified driver circuitry and corresponding low number of lead electrodes.

### SUMMARY OF THE INVENTION

In an aspect of the present invention, a method according to claim 1 is provided. In the method for operating an inkjet print head for generating a droplet of a liquid, the inkjet print head comprises a number of ejection units and each ejection unit comprises a piezo-electric actuator having a signal electrode, a common electrode and a piezo-electric layer interposed between the signal electrode and the common electrode. The method comprises providing a non-jetting pulse signal on a common electrode and providing a jetting pulse signal on a signal electrode.

In the method according to the present invention, there is no need for additional lead electrodes and/or additional signal electrodes, while keeping the driver circuitry simple, since the jetting pulse signal and the non-jetting pulse signal are provided on different actuator electrodes, in particular the signal electrode and the common electrode, respectively.

Further, the method comprises repeating the step of providing the non-jetting pulse signal at a predetermined frequency. Regularly repeating the non-jetting pulse signal is advantageous for vibrating the meniscus of the liquid in or near the nozzle orifice, which prevents the occurrence of dried residue of the liquid in the nozzle orifice. Dried liquid residue in the nozzle orifice is a well-known cause for malfunctioning of an ejection unit. Further, vibrating the meniscus prevents liquid depletion in the nozzle orifice. To prevent liquid flowing through the nozzle orifice, an underpressure is applied on the liquid. When little or no droplets are expelled through the nozzle orifice, the underpressure may result in the meniscus gradually retracting into the ejection unit. Such retracted meniscus is known to increase the chance of an air bubble becoming entrained in the ejection unit as soon as a next droplet ejection is performed. Vibrating the meniscus results in replenishing of the amount of liquid in the nozzle orifice, thereby preventing air bubble entrapment.

Further, in the method according to the present invention, the jetting pulse signal is applied on an ejection unit simultaneously with the non-jetting pulse signal for expelling a droplet. A resulting pulse over the corresponding piezo-electric layer is a superposition of the non-jetting pulse signal and the jetting pulse signal. Thus, amplitude and waveform of the pressure wave in the liquid in the ejection unit is determined by both non-jetting pulse signal and jetting pulse signal. The jetting pulse signal may have an amplitude and waveform that are unsuitable for expelling a droplet, when solely the jetting pulse signal is applied. The superposition of the non-jetting pulse signal and the jetting pulse signal provides for the suitable conditions in the ejection unit for expelling the droplet. Hence, the term ‘jetting pulse signal’ is merely intended to indicate that application of the jetting pulse signal is intended to result in a droplet ejection and does not specify or suggest any properties of the pulse amplitude and/or waveform.

In an embodiment, the method comprises performing the step of providing a non-jetting pulse signal on multiple ejection units simultaneously, in particular on said number of ejection units simultaneously. The common electrode of the ejections units is usually electrically connected to the common electrodes of multiple ejection units and is also known to be electrically connected to the common electrodes of all ejection units of the inkjet print head. Applying the non-jetting pulse signal through the common electrode thus results in applying the non-jetting pulse signal on all electrically connected common electrodes. This may be advantageous, since vibrating the meniscus is usually considered as a desirable measure to prevent disturbances as above described.

Further, generating a vibration in multiple or all ejection units reduces non-uniformity in droplet formation. Without vibrating droplet formation may be dependent on the number of other ejection units driven to expel a droplet due to cross-talk, for example.

Generating a vibration in the other ejection units reduces the differences between droplet ejecting ejection units and not ejecting ejection units. Consequently, the droplet formation is less affected by the number of not ejecting ejection units.

In an embodiment, the method comprises detecting a residual pressure wave in a predetermined ejection unit after said predetermined ejection unit has been provided with a non-jetting pulse signal and has not been provided with a jetting pulse signal; and analyzing the detected residual pressure wave to determine whether a disturbance is present in said predetermined ejection unit. It is well known to probe an ejection unit for disturbances by detecting a residual pressure wave. The waveform and amplitude of the residual pressure wave is determined by inter alia the acoustics of the ejection unit.

Analyzing the residual pressure wave provides detailed information about such acoustics. Any disturbance in the ejection unit changes the acoustics. Hence analysis of the acoustics provides detailed information about the presence of any disturbances. While in the prior art a jetting pulse signal or a dedicated non-jetting pulse signal was applied to the signal electrode prior to residual pressure wave detection, requiring suitable switching circuitry to apply another pulse than the standard jetting pulse signal, in the present invention, the non-jetting pulse signal applied to the common electrode may be used to generate a pressure wave and afterwards detect the residual pressure wave.

In another aspect, the present invention provides an inkjet print head assembly according to claim 6, wherein the inkjet print head assembly is configured for performing the method according to the present invention. In particular, the inkjet print head assembly comprises an inkjet print head and a control circuitry operatively coupled to the inkjet print head. The inkjet print head comprises a number of ejection units and each ejection unit comprises a piezo-electric actuator. Each piezo-electric actuator comprises a signal electrode, a common electrode and a piezo-electric layer interposed between the signal electrode and the common electrode. The control circuitry comprises a jetting driver circuitry for generating a jetting pulse signal and a non-jetting driver circuitry for generating a non-jetting pulse signal. The jetting driver circuitry is electrically connected to the signal electrode of an ejection unit for supplying the jetting pulse signal to said ejection unit. The non-jetting driver circuitry is electrically connected to the common electrode of said ejection unit for supplying the non-jetting pulse signal to said ejection unit. Further, the control circuitry is configured to perform the method according to the present invention.

In an embodiment, the common electrodes of each of the number of ejection units are electrically connected and the non-jetting pulse signal is supplied to each of the number of ejection units simultaneously. Thus, with generating and supplying a single non-jetting pulse signal all electrically connected ejection units are driven to generate a non-droplet-expelling pressure wave in the liquid.

In an embodiment, the jetting driver circuitry comprises switching means for supplying the jetting pulse signal only to a predetermined set of ejection units. While the non-jetting pulse signal may be supplied to all ejection units simultaneously, the jetting pulse signal is to be supplied to predetermined ejection units. For example, if the liquid is an ink for printing an image on a recording medium, the ink is to be supplied image-wise in correspondence with the image to be printed. Suitable switching circuitry is thereto provided, although the switching circuitry may be simplified compared to the prior art, since the switching circuitry may be limited in function to switching between connecting or disconnecting the signal electrode of an ejection unit to or from the jetting driver circuitry.

Further scope of applicability of the present invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given hereinbelow and the accompanying schematical drawings which are given by way of illustration only, and thus are not limitative of the present invention, and wherein:

FIG. 1A shows a perspective view of a first embodiment of an inkjet printer;

FIG. 1B shows a schematical perspective representation of a scanning inkjet printing assembly;

FIG. 1C shows a perspective view of a second embodiment of an inkjet printer;

FIG. 1D shows a schematical perspective representation of a single-pass inkjet printing assembly;

FIG. 2A schematically illustrates a first embodiment of an inkjet print head assembly according to the present invention;

FIG. 2B schematically illustrates a second embodiment of an inkjet print head assembly according to the present invention;

FIG. 2C schematically illustrates a third embodiment of an inkjet print head assembly according to the present invention;

FIG. 3A-3C illustrate a first embodiment of a jetting pulse signal and a non-jetting pulse signal according to the present invention; and

FIG. 4A-4C illustrate a second embodiment of a jetting pulse signal and a non-jetting pulse signal according to the present invention.

### DETAILED DESCRIPTION OF THE DRAWINGS

The present invention will now be described with reference to the accompanying drawings, wherein the same reference numerals have been used to identify the same or similar elements throughout the several views.

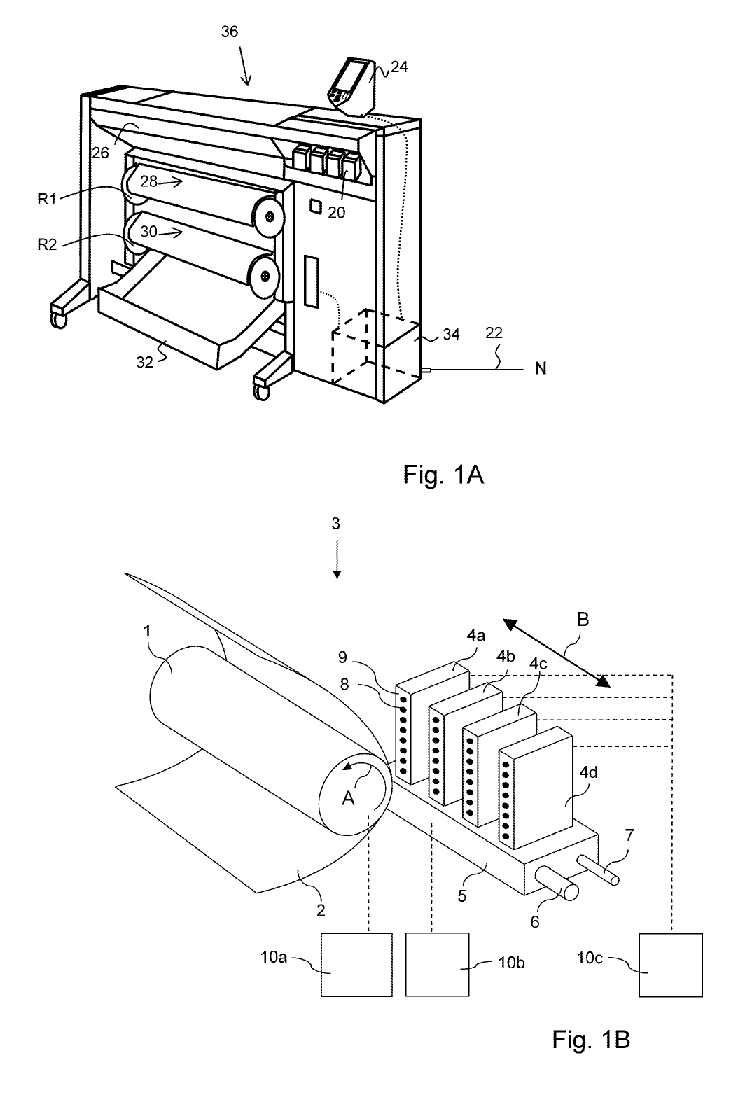

FIG. 1A shows an image forming apparatus 36, in particular an inkjet printer, wherein printing is achieved using a wide-format inkjet printing assembly. The wide-format image forming apparatus 36 comprises a housing 26, wherein the printing assembly, for example the ink jet printing assembly shown in FIG. 1B is placed. The image forming apparatus 36 also comprises a storage means for storing image receiving member 28, 30 (also referred to as a recording medium), a delivery station to collect the image receiving member 28, 30 after printing and storage means for marking material 20. In FIG. 1A, the delivery station is embodied as a delivery tray 32. Optionally, the delivery station may comprise processing means for processing the image receiving member 28, 30 after printing, e.g. a folder or a puncher. The wide-format image forming apparatus 36 furthermore comprises means for receiving print jobs and optionally means for manipulating print jobs. These means may include a user interface unit 24 and/or a control unit 34, for example a computer.

Images are printed on an image receiving member, for example paper, supplied by a roll 28, 30. The roll 28 is supported on the roll support R1, while the roll 30 is supported on the roll support R2. Alternatively, cut sheet image receiving members may be used instead of rolls 28, 30 of image receiving member. Printed sheets of the image receiving member, cut off from the roll 28, 30, are deposited in the delivery tray 32.

Each one of the marking materials for use in the printing assembly are stored in four containers 20 arranged in fluid connection with the respective print heads for supplying marking material to said print heads.

The local user interface unit 24 is integrated to the print engine and may comprise a display unit and a control panel. Alternatively, the control panel may be integrated in the display unit, for example in the form of a touch-screen control panel. The local user interface unit 24 is connected to a control unit 34 placed inside the printing apparatus 36. The control unit 34, for example a computer, comprises a processor adapted to issue commands to the print engine, for example for controlling the print process. The image forming apparatus 36 may optionally be connected to a network N. The connection to the network N is diagrammatically shown in the form of a cable 22, but nevertheless, the connection could be wireless. The image forming apparatus 36 may receive printing jobs via the network. Further, optionally, the controller of the printer may be provided with a USB port, so printing jobs may be sent to the printer via this USB port.

FIG. 1B shows an ink jet printing assembly 3. The ink jet printing assembly 3 comprises supporting means for supporting an image receiving member 2. The supporting means are shown in FIG. 1B as a platen 1, but alternatively, the supporting means may be a flat surface. The platen 1, as depicted in FIG. 1B, is a rotatable drum, which is rotatable about its axis as indicated by arrow A. The supporting means may be optionally provided with suction holes for holding the image receiving member in a fixed position with respect to the supporting means. The ink jet printing assembly 3 comprises print heads 4a-4d, mounted on a scanning print carriage 5. The scanning print carriage 5 is guided by suitable guiding means 6, 7 to move in reciprocation in the main scanning direction B. Each print head 4a-4d comprises an orifice surface 9, which orifice surface 9 is provided with at least one orifice 8. The print heads 4a-4d are configured to eject droplets of marking material onto the image receiving member 2. The platen 1, the carriage 5 and the print heads 4a-4d are controlled by suitable controlling means 10a, 10b and 10c, respectively.

The image receiving member 2 may be a medium in web or in sheet form and may be composed of e.g. paper, cardboard, label stock, coated paper, plastic or textile. Alternatively, the image receiving member 2 may also be an intermediate member, endless or not. Examples of endless members, which may be moved cyclically, are a belt or a drum. The image receiving member 2 is moved in the sub-scanning direction A by the platen 1 along four print heads 4a-4d provided with a fluid marking material.

A scanning print carriage 5 carries the four print heads 4a-4d and may be moved in reciprocation in the main scanning direction B parallel to the platen 1, such as to enable scanning of the image receiving member 2 in the main scanning direction B. Only four print heads 4a-4d are depicted for demonstrating the invention. In practice an arbitrary number of print heads may be employed. In any case, at least one print head 4a-4d per color of marking material is placed on the scanning print carriage 5. For example, for a black-and-white printer, at least one print head 4a-4d, usually containing black marking material is present. Alternatively, a black-and-white printer may comprise a white marking material, which is to be applied on a black image-receiving member 2.

For a full-color printer, containing multiple colors, at least one print head 4a-4d for each of the colors, usually black, cyan, magenta and yellow is present. Often, in a full-color printer, black marking material is used more frequently in comparison to differently colored marking material. Therefore, more print heads 4a-4d containing black marking material may be provided on the scanning print carriage 5 compared to print heads 4a-4d containing marking material in any of the other colors. Alternatively, the print head 4a-4d containing black marking material may be larger than any of the print heads 4a-4d, containing a differently colored marking material.

The carriage 5 is guided by guiding means 6, 7. These guiding means 6, 7 may be rods as depicted in FIG. 1B. The rods may be driven by suitable driving means (not shown). Alternatively, the carriage 5 may be guided by other guiding means, such as an arm being able to move the carriage 5. Another alternative is to move the image receiving material 2 in the main scanning direction B.

Each print head 4a-4d comprises an orifice surface 9 having at least one orifice 8, in fluid communication with a pressure chamber containing fluid marking material provided in the print head 4a-4d. On the orifice surface 9, a number of orifices 8 is arranged in a single linear array parallel to the sub-scanning direction A. Eight orifices 8 per print head 4a-4d are depicted in FIG. 1B, however obviously in a practical embodiment several hundreds of orifices 8 may be provided per print head 4a-4d, optionally arranged in multiple arrays. As depicted in FIG. 1B, the respective print heads 4a-4d are placed parallel to each other such that corresponding orifices 8 of the respective print heads 4a-4d are positioned in-line in the main scanning direction B. This means that a line of image dots in the main scanning direction B may be formed by selectively activating up to four orifices 8, each of them being part of a different print head 4a-4d. This parallel positioning of the print heads 4a-4d with corresponding in-line placement of the orifices 8 is advantageous to increase productivity and/or improve print quality. Alternatively multiple print heads 4a-4d may be placed on the print carriage adjacent to each other such that the orifices 8 of the respective print heads 4a-4d are positioned in a staggered configuration instead of in-line. For instance, this may be done to increase the print resolution or to enlarge the effective print area, which may be addressed in a single scan in the main scanning direction. The image dots are formed by ejecting droplets of marking material from the orifices 8.

Upon ejection of the marking material, some marking material may be spilled and stay on the orifice surface 9 of the print head 4a-4d. The ink present on the orifice surface 9, may negatively influence the ejection of droplets and the placement of these droplets on the image receiving member 2. Therefore, it may be advantageous to remove excess of ink from the orifice surface 9. The excess of ink may be removed for example by wiping with a wiper and/or by application of a suitable anti-wetting property of the surface, e.g. provided by a coating.

FIG. 10 shows another embodiment of an inkjet printing assembly 14 (herein also referred to as a printing apparatus or an inkjet printer), in which the medium support surface 1 is a flat surface. On the flat surface a flexible medium or a non-flexible flat medium may be arranged and may be printed on. The medium support surface 1 is supported on a suitable support structure 12 and a guide beam 16 is arranged over the medium support surface 1. Such guide beam 16 is also known in the art as a gantry.

The guide beam 16 supports the print head carriage 5 such that the print head carriage 5 is enabled to scan in a Y-direction. The guide beam 16 is arranged and configured to be enabled to reciprocate in an X-direction, wherein the X-direction is usually substantially perpendicular to the Y-direction. In a known printing apparatus 14, the guide beam 16 is also arranged and configured to be enabled to move in a Z-direction, which is substantially perpendicular to the X-direction and the Y-direction such to enable to adapt the printing apparatus 14 to a thickness of the recording medium being arranged on the medium support surface 1 and/or to be enabled to print multiple layers on top of each other such to generate height differences in a printed image.

While in FIG. 1B the carriage 5 is illustrated to support four print heads 4a-4d, in practice the carriage 5 may support many print heads. For example, more than four colors of liquid marking material (hereinafter also referred to as ink) may be available. A common additional color is white, but also varnish and silver-colored and gold-colored ink are well known additional colors. Further, for increasing a print speed it is known to provide multiple print heads per color. In particular, two or more print heads per color may be staggered to form a wider print swath per scanning movement.

FIG. 1D illustrates another inkjet printing process, wherein a page-wide array of inkjet print heads 4 is arranged on a carriage 5′. Such an array of inkjet print heads 4 for forming a page-wide array is well-known in the art and therefore not further elucidated herein. In the illustrated embodiment, a transport means 1′ is configured to transport an image receiving member 2, also referred to as a recording medium. The image receiving member 2 is transported in direction A, while the array of inkjet print heads 4 expel droplets of a recording substance (also referred to as ink) image-wise on the recording medium 2. Controlling means 10a controls the transport means 1′, while the controlling means 10c controls the droplet generation by the inkjet print heads 4. The controlling means 10a and 10c are operatively coupled in order to match the transport of the recording medium 2 to the droplet generation of the inkjet print heads 4.

It is noted that, in an embodiment, the recording medium 2 may be held stationary, while transporting the carriage 5′ in the direction A. Such an embodiment may be, for example, using a medium support surface 1 as shown in FIG. 10, wherein the scanning carriage 5 of the embodiment of FIG. 10 is then replaced by the page-wide array carriage 5′ of the embodiment of FIG. 1D. The guide beam 16 (FIG. 10) supports the page-wide array carriage 5′ and transports the page-wide array carriage 5′ in the X-direction during printing.

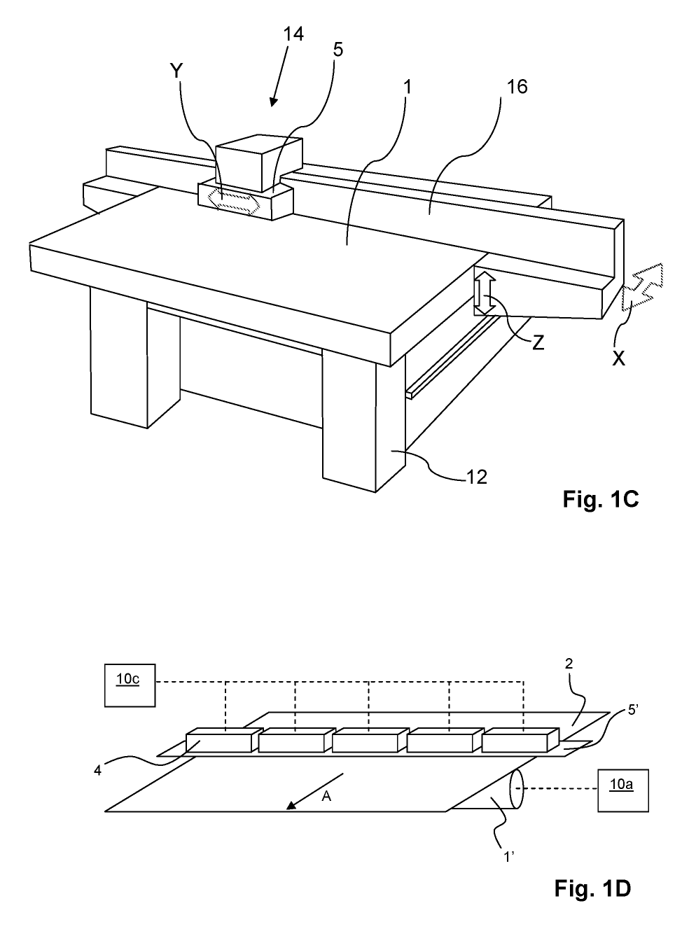

FIG. 2 illustrates an inkjet print head assembly according to the present invention. The inkjet printing assembly comprises an inkjet print head 4 and a control circuitry 100. The inkjet print head 4 comprises an ink inlet 41, a pressure chamber 42 and a nozzle orifice 43. A piezo-electric actuator is operatively coupled to the pressure chamber 42 through a flexible wall 42a. The piezo-electric actuator comprises a common electrode 44, a piezo-electric layer 45 and a signal electrode 46. The common electrode 44 is shown as a bottom electrode and the signal electrode 46 is shown as the top electrode. In a practical embodiment, this may be reversed. In this respect, the position of the common electrode 44 and the signal electrode 46 is not relevant to the present invention. The control circuitry 100 comprises a jetting driver circuitry 101 and a non-jetting driver circuitry 102. The jetting driver circuitry 101 is operatively connected to the signal electrode 46 and the non-jetting driver circuitry 102 is operatively connected to the common electrode 44.

The non-jetting driver circuitry 102 is configured to generate a non-jetting pulse signal, which non-jetting pulse signal provides a voltage to the common electrode 44 upon which the piezo-electric layer 45 will expand or contract. The flexible wall 42a deforms upon the expansion or contraction of the piezo-electric actuator and a pressure wave is generated in a liquid present in the pressure chamber 42. The pressure wave generated by the non-jetting pulse signal has insufficient pressure to expel a droplet, but may result, for example, in a vibration of a liquid meniscus in the nozzle orifice 43. Vibrating the meniscus of the liquid in the nozzle orifice 43 has a number of advantages, which advantages are mostly known from the prior art. The pressure wave generated by the non-jetting pulse signal may also be used as a pre-fire pulse or for generating a residual pressure wave based on which a detection of a disturbance in the pressure chamber 42 and/or the nozzle orifice 43 may be based. Any other application of a non-jetting pulse signal, generated in accordance with the present invention, is contemplated and deemed to be within the scope of the present invention.

The jetting driver circuitry 101 is configured to generate a jetting pulse signal and supply the jetting pulse signal to the signal electrode 46. A voltage of the jetting pulse signal affects the piezo-electric layer 45 due to which the flexible wall 42a deforms as above described. The deforming flexible wall 42a generates a pressure wave, as above described, but in this case, the deformation is larger, generating a stronger pressure wave. The generated pressure wave is such that a droplet of the liquid is expelled through the nozzle orifice 43.

While in the embodiment of FIG. 2A, the control circuitry 100 is provided with a jetting driver circuitry 101 and a non-jetting driver circuitry 102 for a single piezo-actuator, a preferred embodiment illustrated in FIG. 2B is provided with a jetting driver circuitry 101 for each of the three illustrated piezo-actuators and a single non-jetting driver circuitry 102. Of course, in a practical embodiment, the number of piezo-actuators may be significantly larger. In this embodiment of FIG. 2B, a non-jetting pulse signal is thus supplied to multiple piezo-actuators simultaneously. Consequently, in all corresponding pressure chambers, a pressure wave is generated and the menisci are vibrated, for example.

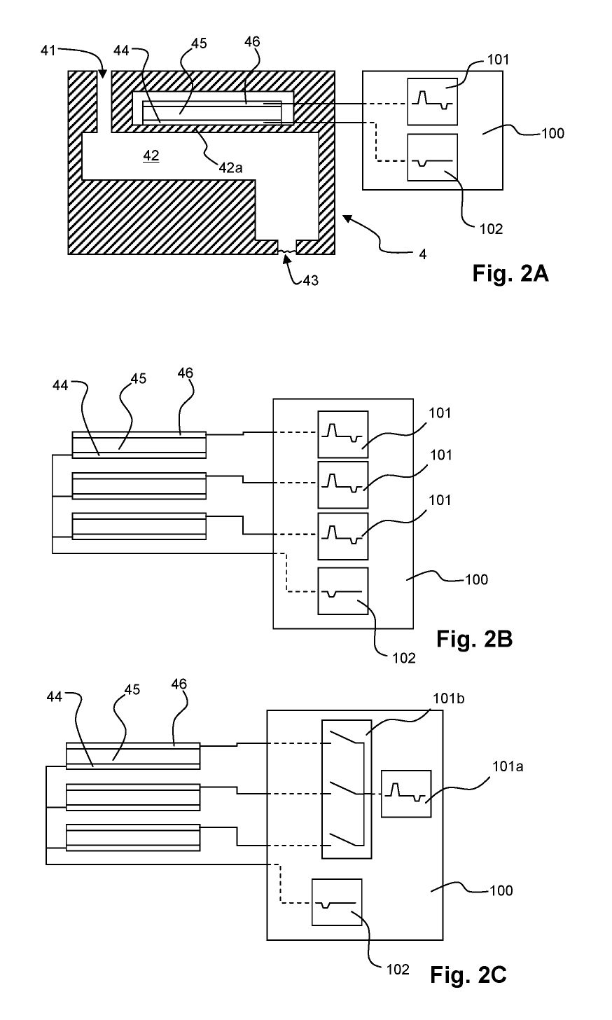

For expelling a droplet, the jetting pulse signal generated by the jetting driver circuitry 101 may be adapted in this embodiment. Since the non-jetting pulse signal is supplied to multiple or even all common electrodes 44, the jetting pulse signal may be designed to be combined with the non-jetting pulse signal. A superposition of the jetting pulse signal and the non-jetting pulse signal may be employed for expelling a droplet, which is described hereinafter in relation to FIG. 3A-3C in more detail.

FIG. 2C illustrates a third embodiment, wherein the jetting driver circuitry is provided by a pulse generating circuitry 101a and a switching circuitry 101b. The jetting pulse signal generating circuitry 101a may regularly at a predetermined frequency generate a jetting pulse signal, while the switching circuitry 101b is controlled to supply the jetting pulse signal only to those signal electrodes 46 that correspond to nozzle orifices 43 through a droplet should be expelled for generating an image, for example.

Other circuitries for controlling operation of an inkjet print head according to the present invention are contemplated too and are therefore deemed within the scope of the present invention. For example, a switching circuitry 101b may as well be added between the common electrodes 44 and the non-jetting driver circuitry 102 such that a non-jetting pulse signal is not always supplied to all common electrodes 44.

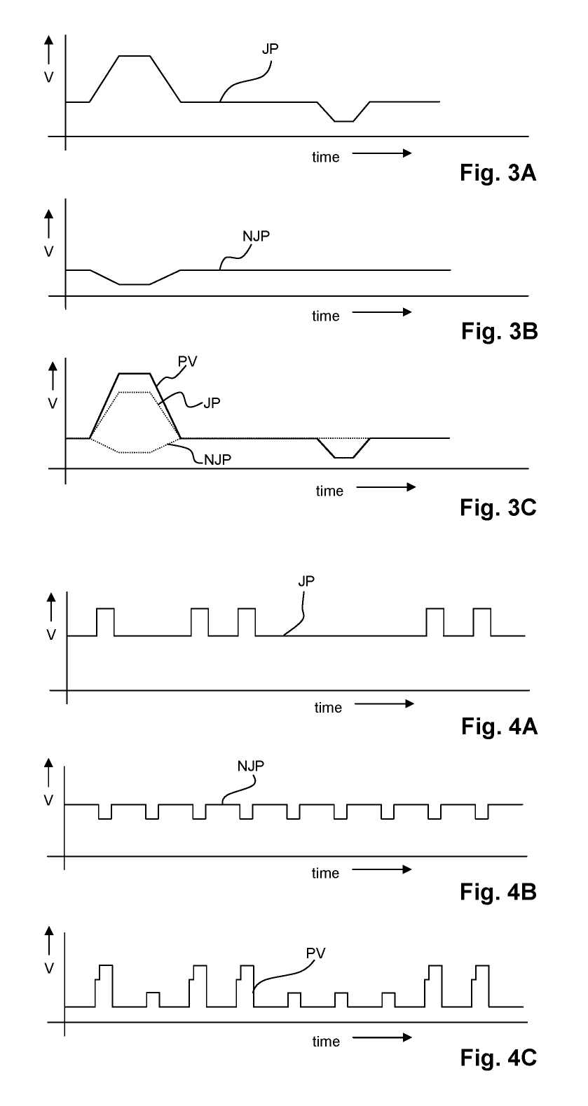

In FIGS. 3A-4C, the horizontal axis represents time and the vertical axis represents a pulse voltage.

FIG. 3A shows an embodiment of a jetting pulse signal JP. The jetting pulse signal JP comprises a droplet generating amplitude DGA in response to which a droplet is actually expelled. After droplet generation, a residual pressure wave remains in the pressure chamber. A quenching pulse QP may damp the residual pressure wave considerably.

The quenching pulse QP is, at least with respect to the present invention, merely optional. For example, in a practical embodiment, a time period between subsequent droplet generations may be sufficient to allow the residual pressure wave to dampen. FIG. 3B shows an exemplary embodiment of a non-jetting pulse signal NJP. The maximum amplitude of the non-jetting pulse signal NJP is considerably lower than a maximum amplitude of the jetting pulse signal JP shown in FIG. 3A. Further, the non-jetting pulse signal NJP is shown to have a negative amplitude contrary to the positive amplitude of the jetting pulse signal JP shown in FIG. 3A. It is noted that such reverse amplitude provides a same deformation due to the fact that the jetting pulse signal JP and the non-jetting pulse signal NJP are supplied to the opposing signal electrode and common electrode, respectively. Hence, both provide a same direction of an electric field over the piezo-electric layer.

Based on the reversed amplitudes, the jetting pulse signal JP and the non-jetting pulse signal NJP may be superimposed as shown in FIG. 3C. The jetting pulse signal JP and the non-jetting pulse signal NJP are shown in dotted lines. A piezo-actuator voltage PV, i.e. a total voltage between the signal electrode and the common electrode, is equal to a sum of the jetting pulse signal JP and the inverse of the non-jetting pulse signal NJP. The piezo-actuator voltage PV is the voltage based on which the piezo-electric layer actually contracts or expands.

In FIG. 3A-3C and in particular in FIG. 3C, the jetting pulse signal JP and the non-jetting pulse signal NJP are shown and described to be in phase, which allows to form a jetting piezo-electric voltage PV, while the jetting pulse signal JP may be insufficient to generate a droplet. In another embodiment, the non-jetting pulse signal NJP may be out-of-phase compared to the jetting pulse signal JP. For example, the non-jetting pulse signal NJP may replace the quenching pulse QP, wherein a residual pressure wave after application of the non-jetting pulse signal NJP may be comparable to a pressure wave generated in other pressure chambers, where no jetting pulse signal JP has been provided such that in all pressure chambers a similar pressure wave remains.

In yet another embodiment, the non-jetting pulse signal NJP may be selectively supplied in order to affect a droplet size or speed. In such embodiment, the jetting pulse signal JP may provide for a small droplet if no non-jetting pulse signal NJP is supplied simultaneously, while addition of the non-jetting pulse signal NJP may result in a larger droplet being expelled.

FIGS. 4A-4C illustrate another embodiment, wherein a jetting pulse signal JP is provided at moments in time determined by, for example, an image to be printed. A non-jetting pulse signal NJP is supplied at a predetermined frequency, resulting in a continuous vibration of the meniscus. The non-jetting pulse signal NJP is shorter than the jetting pulse signal JP and shifted in time compared to the jetting pulse signal JP. Upon application of the jetting pulse signal JP, a complex piezo-electric voltage PV results. As shown in FIG. 4C, first the piezo-electric voltage PV for generating a droplet increases, then it remains constant for a short time and then it increases further due to the application of the non-jetting pulse signal NJP. Thus, the drive pulse for generating a droplet may be shaped by suitably selecting a waveform for the jetting pulse signal JP and the non-jetting pulse signal NJP and by suitably selecting a timing for each of the jetting pulse signal JP and the non-jetting pulse signal NJP.

Although the amplitudes for the jetting pulse signal JP and the non-jetting pulse signal NJP are shown to be reversed, in an embodiment, the amplitudes may be of similar polarity. In such embodiment, when the jetting pulse signal JP and the non-jetting pulse signal NJP are applied simultaneously, the voltages of both need to be deducted from each other. Apart from that difference, the use and functioning of the two pulses remains the same and is therefore deemed to be within the scope of the present invention.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, features presented and described in separate dependent claims may be applied in combination and any advantageous combination of such claims is herewith disclosed.

Further, it is contemplated that structural elements may be generated by application of three-dimensional (3D) printing techniques. Therefore, any reference to a structural element is intended to encompass any computer executable instructions that instruct a computer to generate such a structural element by three-dimensional printing techniques or similar computer controlled manufacturing techniques. Furthermore, such a reference to a structural element encompasses a computer readable medium carrying such computer executable instructions.

Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. Method for operating an inkjet print head for generating a droplet of a liquid, wherein the inkjet print head comprises a number of ejection units, each ejection unit comprising a piezo-electric actuator having a signal electrode, a common electrode and a piezo-electric layer interposed between the signal electrode and the common electrode, the method comprising
a) providing a non-jetting pulse signal on a common electrode, the non-jetting pulse signal being adapted to generate a pressure wave in the liquid in the corresponding ejection unit without expelling a droplet of the liquid; and
b) providing a jetting pulse signal on a signal electrode, the jetting pulse signal being adapted to generate a pressure wave in the liquid in the corresponding ejection unit such that a droplet of the liquid is expelled; and
wherein the method comprises repeating step a) at a predetermined frequency for vibrating a meniscus of the liquid; and
wherein the jetting pulse signal is applied on an ejection unit simultaneously with the non-jetting pulse signal such that a resulting pulse over the corresponding piezo-electric layer is a superposition of the non-jetting pulse signal and the jetting pulse signal for ejecting the droplet.

2. Method according to claim 1, wherein the method comprises performing step a) on multiple ejection units simultaneously, in particular on said number of ejection units simultaneously.

3. Method according to claim 1, wherein the method comprises
c) detecting a residual pressure wave in a predetermined ejection unit after said predetermined ejection unit has been provided with a non-jetting pulse signal and has not been provided with a jetting pulse signal;
d) analyzing the detected residual pressure wave to determine whether a disturbance is present in said predetermined ejection unit.

4. Inkjet print head assembly comprising an inkjet print head and a control circuitry operatively coupled to the inkjet print head, wherein
the inkjet print head comprises a number of ejection units, each ejection unit comprising a piezo-electric actuator having a signal electrode, a common electrode and a piezo-electric layer interposed between the signal electrode and the common electrode; and
the control circuitry comprises a jetting driver circuitry for generating a jetting pulse signal and a non-jetting driver circuitry for generating a non-jetting pulse signal; and
wherein the jetting driver circuitry is electrically connected to the signal electrode of an ejection unit for supplying the jetting pulse signal to said ejection unit and the non-jetting driver circuitry is electrically connected to the common electrode of said ejection unit for supplying the non-jetting pulse signal to said ejection unit and wherein the control circuitry is configured to perform the method according to claim 1.

5. Inkjet print head assembly according to claim 4, wherein the common electrode of each of the number of ejection units are electrically connected and wherein the non-jetting pulse signal is supplied to each of the number of ejection units simultaneously.

6. Inkjet print head assembly according to claim 4, wherein the jetting driver circuitry comprises switching means for supplying the jetting pulse signal only to a predetermined set of ejection units.
